(19) United States
(12) Patent Application Publication
(10) Pub. No.: US 2014/0060004 A1
(43) Pub. Date: Mar. 6, 2014

(54) TILTROTOR VECTORED EXHAUST SYSTEM

(71) Applicants: Thomas M. Mast, Carrollton, TX (US); Keith C. Pedersen, Fort Worth, TX (US); David L. Miller, North Richland Hills, TX (US); Steven Ray Ivans, Ponder, TX (US)

(72) Inventors: Thomas M. Mast, Carrollton, TX (US); Keith C. Pedersen, Fort Worth, TX (US); David L. Miller, North Richland Hills, TX (US); Steven Ray Ivans, Ponder, TX (US)

(73) Assignee: BELL HELICOPTER TEXTRON INC., FORT WORTH, TX (US)

(21) Appl. No.: 13/584,286

(22) Filed: Aug. 13, 2012

Related U.S. Application Data
(60) Provisional application No. 61/536,650, filed on Sep. 20, 2011.

(51) Int. Cl. B64C 27/28

(52) U.S. Cl. CPC B64C 27/28
USPC 60/204; 60/228

(57) ABSTRACT

The exhaust system is located on each nacelle of a tiltrotor aircraft. The exhaust system includes a vector nozzle that is selectively rotatable in relation to each nacelle in order to achieve certain performance objectives. The vector nozzle can be oriented to provide maximum flight performance, reduce infrared (IR) signature, or even to reduce/prevent ground heating.

### BACKGROUND

1. Technical Field

The present application relates to a vectored exhaust system for an aircraft.

2. Description of Related Art

A conventional tiltrotor aircraft has an exhaust that is fixed in a specific direction. When the tiltrotor nacelles are vertically oriented to fly in helicopter mode, the hot exhaust gases are directed downward. When the tiltrotor nacelles are horizontally oriented to fly in airplane mode, the hot exhaust gases are directed aft. When the tiltrotor is on the ground, the nacelles are vertically oriented such that the hot exhaust gases are directed towards the ground. In some operational situations, a ground run can cause a risk of damage to the ground surface due to a concentration of the hot exhaust gases. Further, a conventional tiltrotor aircraft does not have an ability to actively control the perceived infrared (IR) signature of the hot exhaust.

Hence, there is a need for an improved exhaust system for a tiltrotor aircraft.

### DESCRIPTION OF THE DRAWINGS

The novel features believed characteristic of the system of the present application are set forth in the appended claims. However, the system itself, as well as a preferred mode of use, and further objectives and advantages thereof, will best be understood by reference to the following detailed description when read in conjunction with the accompanying drawings, wherein:

FIG. 1 is a side view of a tiltrotor aircraft having an exhaust system, according to an illustrative embodiment of the present application;

FIG. 2 is a side view of the tiltrotor aircraft having the exhaust system, according to the illustrative embodiment of the present application;

FIG. 3 is a side view of the tiltrotor aircraft having the exhaust system, according to the illustrative embodiment of the present application;

FIG. 4 is a side view of the tiltrotor aircraft having the exhaust system, according to the illustrative embodiment of the present application;

FIG. 5 is a side view of the tiltrotor aircraft having the exhaust system, according to the illustrative embodiment of the present application;

FIG. 6 is a rear view of the tiltrotor aircraft having the exhaust system, according to an illustrative embodiment of the present application;

FIG. 7 is a side view of an exhaust system, according to an illustrative embodiment of the present application;

FIG. 8 is a rear view of the exhaust system, according to the illustrative embodiment of the present application;

FIG. 9 is a partially removed top view of the exhaust system, according to the illustrative embodiment of the present application;

FIG. 10 is a partially removed rear view of the exhaust system, according to the illustrative embodiment of the present application;

FIG. 11 is a partially removed side view of the exhaust system, according to the illustrative embodiment of the present application;

FIG. 12 is a partially removed bottom view of the exhaust system, according to the illustrative embodiment of the present application;

FIG. 13 is a partially removed side view of the exhaust system, according to the illustrative embodiment of the present application;

FIG. 14 is a partially removed cross-sectional view of the exhaust system, taken at section lines 14-14 in FIG. 12, according to the illustrative embodiment of the present application; and

FIG. 15 is a schematic view of a control system for controlling the exhaust system, according to an illustrative embodiment of the present application.

### DESCRIPTION OF THE PREFERRED EMBODIMENT

Illustrative embodiments of the system are described below. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the system described herein may be oriented in any desired direction.

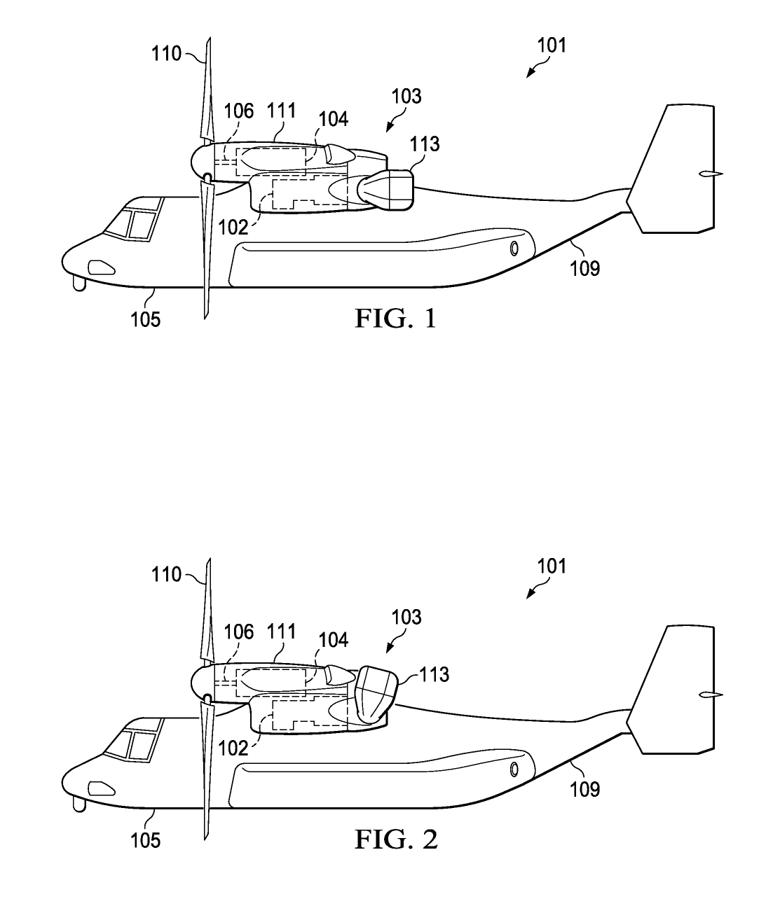

Referring to FIGS. 1-6, an example tiltrotor aircraft 101 is illustrated. Aircraft 101 includes a fuselage 105, a wing 107 and a tail member 109. Rotatable nacelles 111 are coupled to each end portion of wing 107. The nacelle 111 located on the left side of wing 107 is a mirror image of the nacelle 111 located on the right side of wing 107. Each nacelle 111 houses a propulsion system including an engine 102, a gearbox 104, and drive shaft 106. A plurality of rotor blades 110 are operably associated with a drive shaft in each nacelle 111.

Aircraft 101 is configured to fly in a helicopter mode, in which nacelles 111 are positioned approximately vertical. In addition, aircraft 101 is configured to fly in an airplane mode, in which nacelles 111 are positioned approximately horizontal. It should be appreciated that nacelles 111 can be oriented at any positioned between vertical and horizontal, which can correspond with flying in a conversion mode.

An exhaust system 103 is located on each nacelle 111. For clarity, only the left side nacelle 111 and exhaust system 103 are detailed herein. The right side nacelle 111 is a mirror image of the left side nacelle 111, as one of ordinary skill in the art would fully appreciate having benefit of this disclosure. Exhaust system 103 is configured with a vector nozzle 113. Vector nozzle 113 can be selectively rotated in relation to aircraft 101 and/or nacelle 111 in order to achieve certain desirables. For example, vector nozzle 113 can be oriented to provide maximum flight performance, reduce IR signature, or even to reduce/prevent ground heating, as further described herein.

Referring to FIG. 1, aircraft 101 is illustrated in an airplane mode with vector nozzle 113 selectively oriented to direct exhaust gases in an aft direction. In such a configuration, thrust from the exhaust gas is directed aftward, thereby contributing to forward propulsion of aircraft 101.

Referring to FIG. 2, aircraft 101 is illustrated in an airplane mode with vector nozzle 113 selectively oriented to direct exhaust gases in an upward direction. In such a configuration, a hot interior portion of exhaust system 103 is hidden from line-of-site of most potential threats, thereby directionally suppressing the perceived infrared (IR) signature of aircraft 101. More specifically, a heat seeking weapon deployable from a lower elevation location, as compared to the elevation of aircraft 101, may not have a line-of-site view of the hot interior portion of exhaust system 103, when vector nozzle 113 is positioned accordingly.

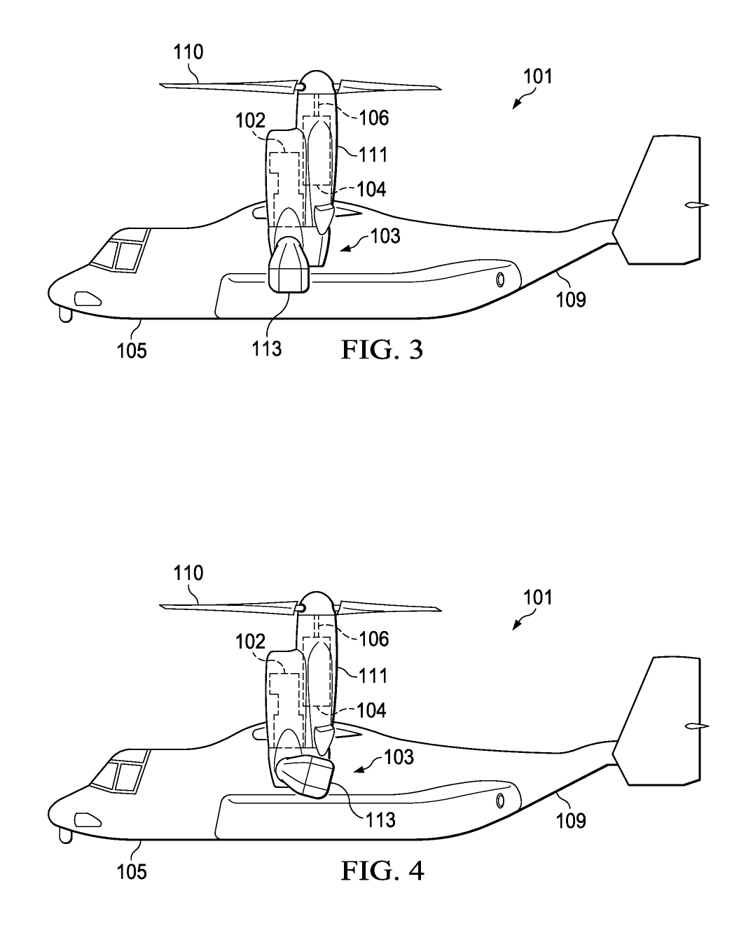

Referring to FIG. 3, aircraft 101 is illustrated in a helicopter mode with vector nozzle 113 selectively oriented to direct exhaust gases in a downward direction. In such a configuration, thrust from the exhaust gas is directed down, thereby contributing to vertical lift of aircraft 101. In such a configuration, the hot exhaust gases can contribute to ground heating; however, the directional thrust from the exhaust gas contributes to lift performance of aircraft 101.

Referring to FIG. 4, aircraft 101 is illustrated in a helicopter mode with vector nozzle 113 selectively oriented to direct exhaust gases in an aft direction. In such a configuration, the flow of hot exhaust gas is directed aft so as to reduce/prevent heating of the ground surface below each nacelle 111. In such a configuration, the directed thrust from vector nozzle 113 does not contribute or hinder vertical lift of the aircraft 101. However, a hot portion of the interior of the exhaust system 103 may be viewable in a line-of-site view from a position aft of the aircraft 101.

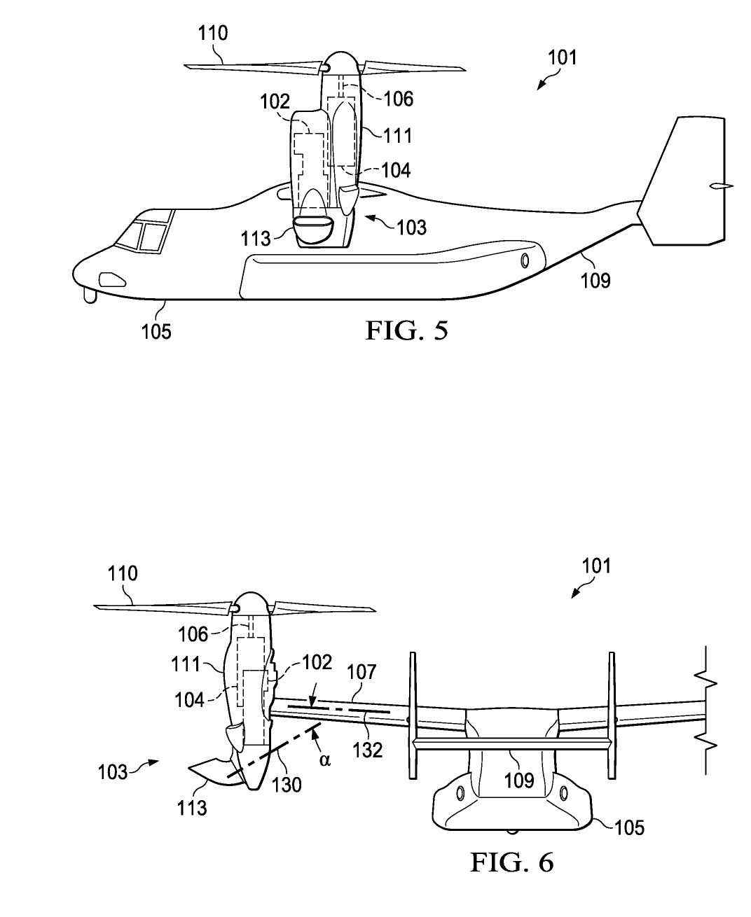

Referring to FIGS. 5 and 6, aircraft 101 illustrated in a helicopter mode with vector nozzle 113 selectively oriented to direct exhaust gas in an upward/outboard direction. In such a configuration, the directed thrust from vector nozzle 113 may reduce vertical thrust of the aircraft 101; however, a hot portion of the interior of the exhaust system 103 can be substantially hidden from line-of-sight viewing from ground positions.

Vector nozzle 113 can be selectively rotated to achieve certain desirables even during rotation of nacelle 111 between helicopter mode and airplane mode orientations. For example, because vector nozzle 113 has a nozzle rotational axis 130 that is approximately parallel to a nacelle rotational axis 132, vector nozzle 113 can approximately maintain its relative orientation even while nacelle 111 rotates. The relative angle a between nozzle rotational axis 130 and nacelle rotational axis 132 is preferably approximately zero; however, even acute angles, such as less than 20 degrees, can provide desirable results. During operation, aircraft 101 can be in IR suppression mode such that vector nozzle 113 can be oriented to maintain the direction of exhaust gas in an upward/outboard direction. When tiltrotor 101 is in helicopter mode, vector nozzle 113 can be oriented as shown in FIGS. 5 and 6. However, as nacelle 111 is rotated into airplane mode position, vector nozzle 113 can be rotated in the opposite direction (relative to nacelle 111) so that the exhaust gas direction is maintained in an upward/outboard direction. Because the nozzle rotational axis 130 and nacelle rotational axis 132 are approximately parallel, the exhaust gas direction can be maintained in an upward/outboard direction through the relative rotation between nacelle 111 and vector nozzle 113. This feature of vector nozzle 113 provides for effective suppression of the IR signature through conversion from helicopter mode to airplane mode.

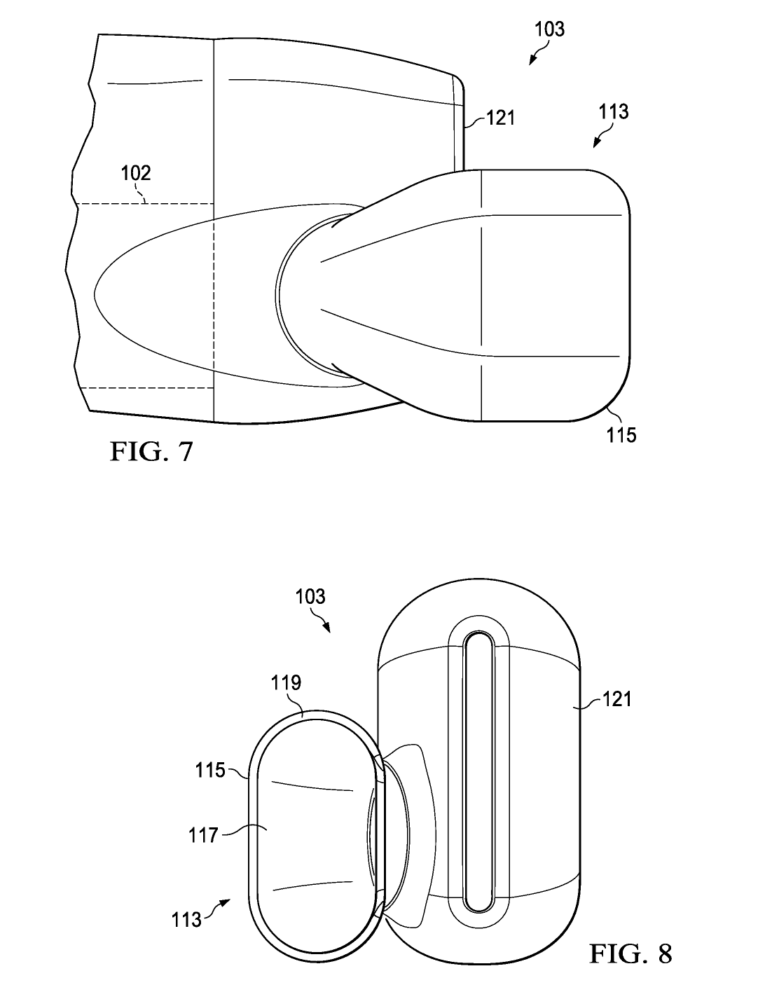

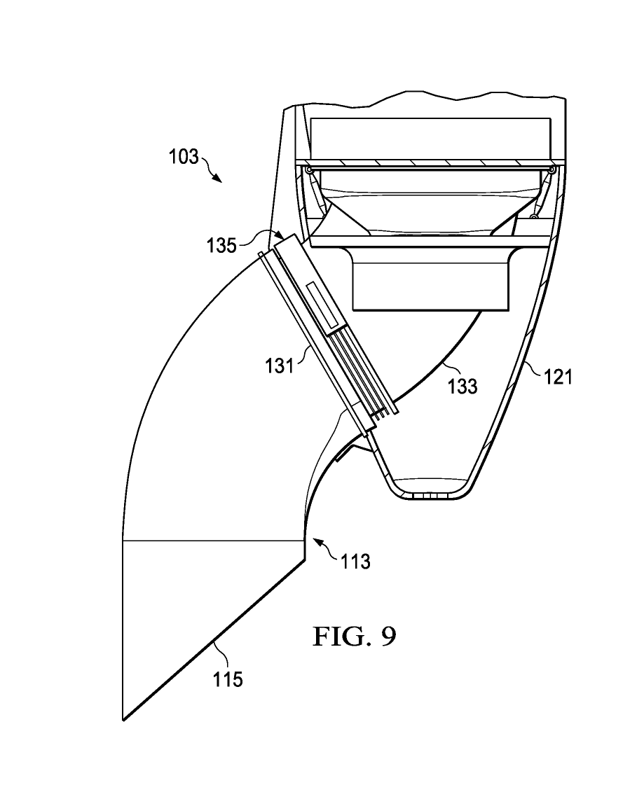

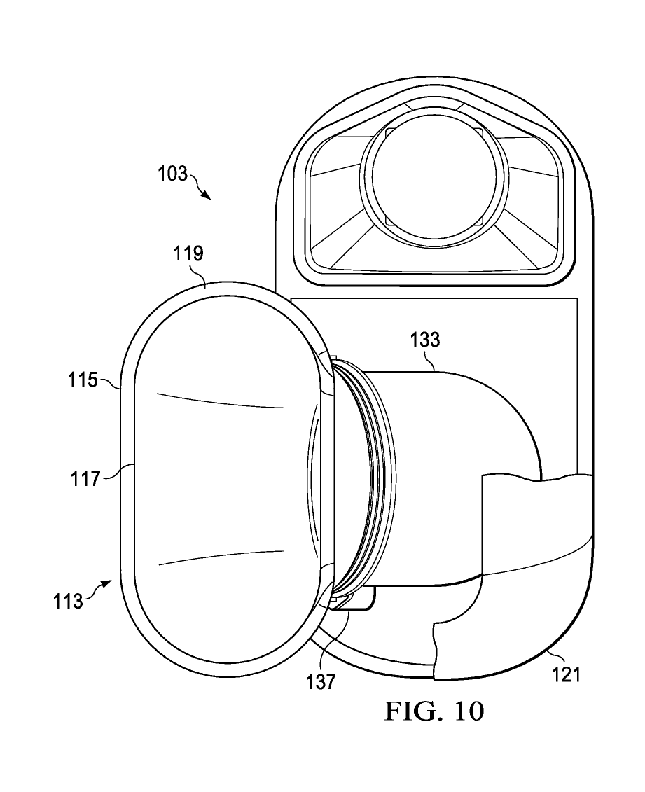

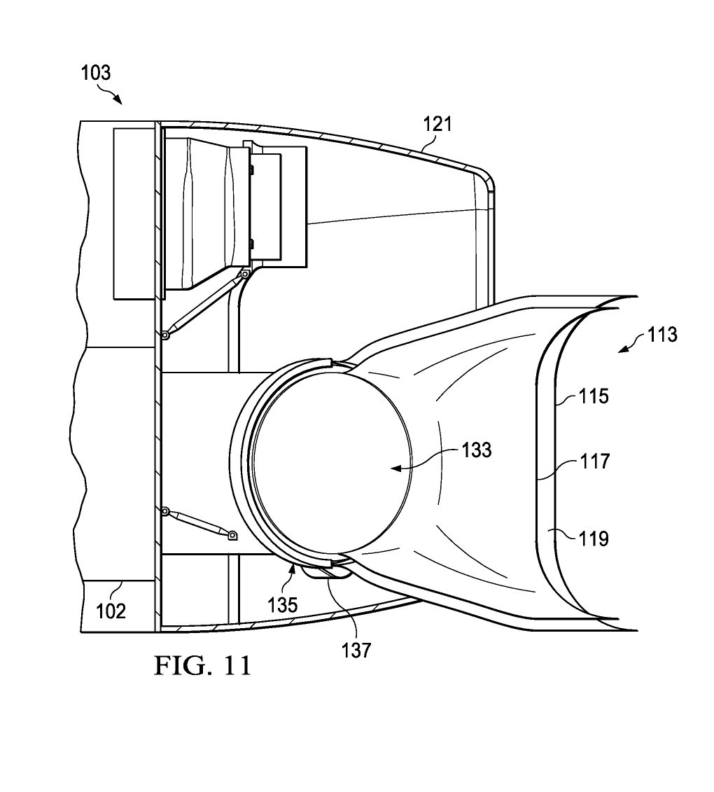

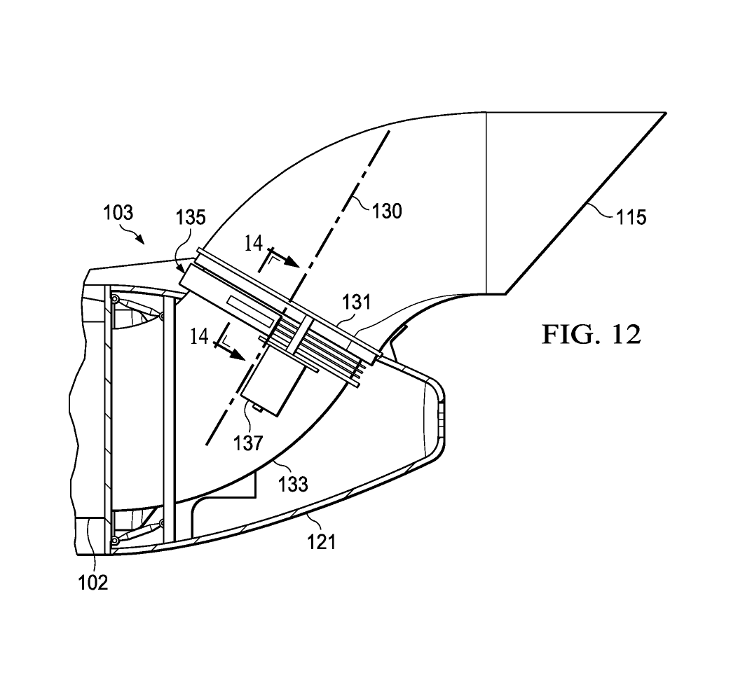

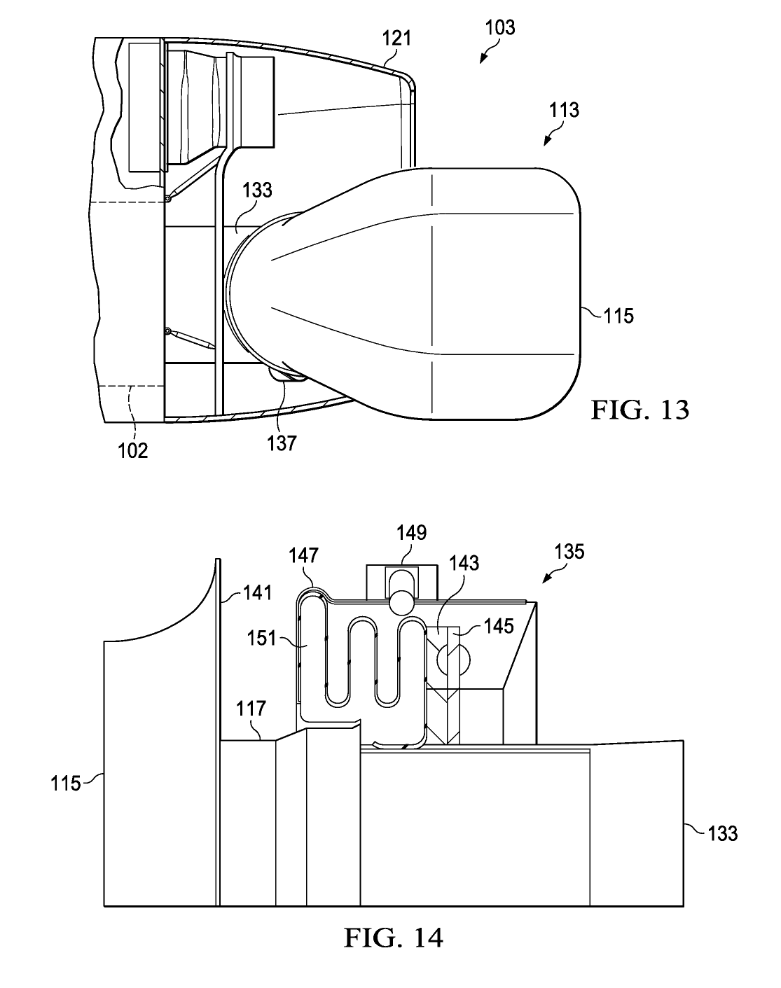

Referring now also to FIGS. 7-14, exhaust system 103 illustrated in further detail. Vector nozzle 113 can include an outer exhaust duct 115 and a primary exhaust duct 117. Primary exhaust duct 117 is in gaseous fluid communication with the hot engine exhaust via a main engine fixed exhaust 133. A gap 119 between outer exhaust duct 115 and primary exhaust duct 117 can promote the flow of cooling air between of outer exhaust duct 115 and primary exhaust duct 117, so that the IR signature of exhaust system 103 is reduced. More specifically, cool air from the inside of an exhaust fairing 121 is drawn into gap 119 via an inlet 141, so as to provide cooling between the hot primary exhaust duct 117 and outer exhaust duct 115. Further, outer exhaust duct 115 at least partially hides primary exhaust duct 117 from line-of-site vision. As discussed further herein, certain rotational positions of vector nozzle 113 hide primary exhaust duct 117 from line-of-site vision of IR detectors. During operation, primary exhaust duct 117 is considerably hotter than outer exhaust duct 115. As such, exhaust system 103 is configured to selectively position vector nozzle 113 to hide of primary exhaust duct 117 from line-of-site vision of the predicted threat location.

Vector nozzle 113 can be selectively rotated with a control system and a vector nozzle pivot assembly 135. Pivot assembly 135 can include a pivot drive motor 137 mounted to a non-rotating structure. Drive motor 137 imparts a rotational force upon vector nozzle 113 with a flexible drive belt 131 wrapped around a rotating portion of the vector nozzle 113. It should be appreciated that pivot drive motor 137 is merely illustrative of a wide variety of actuator systems that may be used to rotate vector nozzle 113. However, with the illustrated geometry, rotation of vector nozzle 113 can be accomplished with a single pivot joint, thus decreasing complication as compared to other possible vectoring systems. Further, vector nozzle 113 is configured to only rotate about a single axis of rotation 130, thereby achieving efficiency in the mechanical system.

Referring now in particular to FIG. 14, a sectional view is illustrated to detail the rotating and non-rotating portions of the exhaust system 103. A thrust bearing includes a non-rotating portion 143 and a rotating portion 145. Rotating portion 145 is coupled to a rotating flange 147. Rotating flange 147 is also coupled to primary exhaust duct 117 and a bellows seal 151. Bellows seal 151 presses against non-rotating portion 143 of the thrust bearing to create a seal capable of withstanding thermal expansion/contraction. Bellows seal 151 also presses against the main engine fixed exhaust 133. A flange clamp 149 can be used to secure the flange components.

Exhaust system 103 illustrated in FIGS. 7-14 is merely illustrative of a variety of configurations that may be used to allow a vector nozzle 113 to selectively rotate adjacent to a non-rotating exhaust 133.

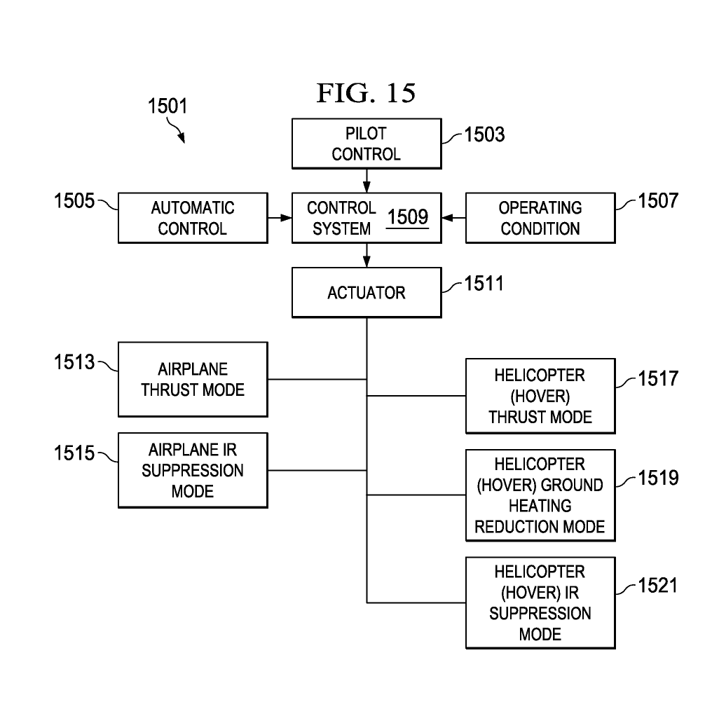

Referring now to FIG. 15, a system 1501 is schematically illustrated to detail the functionality and capabilities of the exhaust system of the present application. System 1501 can include a pilot input 1503 for allowing the pilot to input desired positions of the vector nozzle. An automatic control input 1505 can allow the system 1501 to automatically position the vector nozzle. A control system 1509 can receive a data 1507 pertaining to operating conditions of the aircraft. For example, data 1507 can include information related to any perceived threats, the locations of the perceived threats, nacelle position, current aircraft speed/altitude, and current aircraft payload, to name a few. Control system 1509 is configured to send actuation signals to an actuator 1511 in order to selectively position the vector nozzle. Further, control system 1509 determines and dictates the appropriate position of the vector nozzle in part from data 1507.

The position of vector nozzle in an airplane thrust mode 1513 corresponds with the position illustrated in FIG. 1. The position of vector nozzle in an airplane IR suppression mode 1515 corresponds with the position illustrated in FIG. 2. The position of vector nozzle in a helicopter (hover) thrust mode 1517 corresponds with the position illustrated in FIG. 3. The position of vector nozzle in a helicopter (hover) ground heating mode 1519 corresponds with the position illustrated in FIG. 4. The position of vector nozzle in a helicopter (hover) IR suppression mode 1521 corresponds with the position illustrated in FIGS. 5 and 6.

Further, if operation condition 1507 sends data to control system 1509 indicating that the aircraft is operating in a high enemy threat situation, then control system 1509 can command actuator 1511 to position vector nozzle in airplane IR suppression mode 1515 (when in airplane mode) and helicopter IR suppression mode 1521 (when in a hover). Further, if operation condition 1507 sends data to control system 1509 indicating that the aircraft is not operating in a high enemy threat situation and it is desirable to have maximum aircraft performance, then control system 1509 can command actuator 1511 to position vector nozzle in airplane thrust mode 1513 (when in airplane mode) and helicopter thrust mode 1517 (when in a hover). Further, if operation condition 1507 sends data to control system 1509 indicating that the aircraft is not operating in a high enemy threat situation and it is desirable to prevent ground surface heating, then control system 1509 can command actuator 1511 to position vector nozzle in helicopter ground heating reduction mode 1519 (when in a hover). It should be appreciated that system 1501 can be configured to position vector nozzle 113 in hybrid positions, especially during operation of the aircraft between airplane and helicopter modes.

The exhaust system of the present application provides significant advantages, including: 1) providing IR suppression that is threat selectable; 2) providing an exhaust system that can reduce ground heating when in helicopter mode; and 3) providing an exhaust system that can selectively position the thrust vector to increase performance in a variety of flight situations.

The particular embodiments disclosed above are illustrative only, as the apparatus may be modified and practiced in different but equivalent manners apparent to those skilled in the art having the benefit of the teachings herein. Modifications, additions, or omissions may be made to the apparatuses described herein without departing from the scope of the invention. The components of the apparatus may be integrated or separated. Moreover, the operations of the apparatus may be performed by more, fewer, or other components.

Furthermore, no limitations are intended to the details of construction or design herein shown, other than as described in the claims below. It is therefore evident that the particular embodiments disclosed above may be altered or modified and all such variations are considered within the scope and spirit of the application. Accordingly, the protection sought herein is as set forth in the claims below.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

1. An exhaust system for a tiltrotor aircraft, the exhaust system comprising:
a fixed exhaust in gaseous communication with an engine;
a primary exhaust duct in gaseous communication with the fixed exhaust, the primary exhaust being rotatable relative to the fixed exhaust about a nozzle rotational axis; and
a nacelle configured as a housing for the engine, the nacelle being rotatable relative to a wing of the tiltrotor aircraft about a nacelle rotational axis;
wherein the nozzle rotational axis and the nacelle rotational axis are approximately parallel.

2. The exhaust system according to claim 1, further comprising:
wherein the nacelle is rotatably between an approximately vertical orientation configurable for a helicopter mode operation of the tiltrotor aircraft and an approximately horizontal orientation configurable for an airplane mode operation of the tiltrotor aircraft.

3. The exhaust system according to claim 2, wherein the primary exhaust duct is configured to selectively direct an exhaust flow in an aft direction while the nacelle is vertically oriented.

4. The exhaust system according to claim 2, wherein the primary exhaust duct is configured to selectively direct an exhaust flow in an upward/outboard direction while the nacelle is vertically oriented.

5. The exhaust system according to claim 2, wherein the primary exhaust duct is configured to selectively direct an exhaust flow in an upward/outboard direction while the nacelle is horizontally oriented.

6. The exhaust system according to claim 1, further comprising:
an outer exhaust duct located adjacent to the primary exhaust duct creating a gap therebetween.

7. The exhaust system according to claim 6, wherein the gap is configured for the flow of cooling air between the primary exhaust duct and the outer exhaust duct.

8. The exhaust system according to claim 7, wherein the cooling air is drawn from an inlet formed between a base portion of the outer exhaust duct and the primary exhaust duct.

9. The exhaust system according to claim 6, further comprising:
an actuator configured for imparting a rotational force to the primary exhaust duct.

10. The exhaust system according to claim 9, further comprising:
a drive belt operably associated with the actuator, the drive belt at least partially wrapped around the outer exhaust duct.

11. The exhaust system according to claim 1, further comprising:
a bellows seal in pressing contact with the fixed exhaust and the primary exhaust duct, the bellows seal being configured to prevent the leakage of exhaust gas while allowing a relative rotation between the fixed exhaust and the primary exhaust duct.

12. An exhaust system for a tiltrotor aircraft, the exhaust system comprising:
a nacelle configured for housing an engine, the nacelle being rotatable relative to a wing of the tiltrotor aircraft, wherein the nacelle is rotatably between an approximately vertical orientation configurable for a helicopter mode operation of the tiltrotor aircraft and an approximately horizontal orientation configurable for an airplane mode operation of the tiltrotor aircraft;
a fixed exhaust in gaseous communication with an engine;
a vector nozzle comprising:
a primary exhaust duct in gaseous communication with the fixed exhaust, the primary exhaust being rotatable relative to the fixed exhaust;
a control system configured to process an input to selectively command an actuator to rotate the vector nozzle.

13. The exhaust system according the claim 12, wherein the input is one of:
a pilot control input;
an operating condition input; and
an automatic control input.

14. The exhaust system according the claim 12, wherein the control system is configured to selectively position the vector nozzle in a helicopter hover ground heating reduction mode such that an exhaust flow is directed in an aftward direction while the nacelle is positioned approximately vertical.

15. The exhaust system according the claim 12, wherein the control system is configured to selectively position the vector nozzle in a helicopter hover infrared signature suppression mode such that an exhaust flow is directed in an upward direction while the nacelle is positioned approximately vertical.

16. The exhaust system according the claim 12, wherein the control system is configured to selectively position the vector nozzle in an airplane infrared signature suppression mode such that an exhaust flow is directed in an upward direction while the nacelle is positioned approximately horizontal.

17. The exhaust system according the claim 12, the vector nozzle further comprising:
an outer exhaust duct located adjacent to the primary exhaust duct creating a gap therebetween, the outer exhaust duct being configured to hide the primary exhaust duct from a line of site vision of an infrared signature detector.

18. The exhaust system according to claim 12, the vector nozzle further comprising:
an outer exhaust duct located adjacent to the primary exhaust duct creating a gap therebetween, the gap being configured to allow for a flow of cooling air between the primary exhaust duct and the outer exhaust duct.

19. A method of suppressing infrared signature of a tiltrotor aircraft having a nacelle, the method comprising:
orienting a rotatable vector nozzle to direct an exhaust gas in an upward direction;
maintaining an approximate orientation of the rotatable vector nozzle as the nacelle rotates between a vertical position and a horizontal position by rotating the rotatable vector nozzle relative to the nacelle.

20. The method according to claim 19, wherein the step of maintain the approximate orientation of the rotatable vector nozzle is achieved by rotating the vector nozzle in the opposite direction of the nacelle rotation direction.
